(19) United States
(12) Patent Application Publication
(10) Pub. No.: US 2025/0046263 A1
(43) Pub. Date: Feb. 6, 2025

(54) DISPLAY PANEL, DRIVING METHOD THEREOF, AND DISPLAY APPARATUS

(71) Applicant: BOE Technology Group Co., Ltd., Beijing (CN)

(72) Inventors: Yuzhen GUO, Beijing (CN); Baoxi WANG, Beijing (CN); Haoliang ZHENG, Beijing (CN); Li XIAO, Beijing (CN); Lipeng GAO, Beijing (CN); Jiao ZHAO, Beijing (CN); Xiaorong CUI, Beijing (CN); Yichi ZHANG, Beijing (CN)

(21) Appl. No.: 18/618,985

(22) Filed: Mar. 27, 2024

Related U.S. Application Data
(63) Continuation of application No. PCT/CN2023/110306, filed on Jul. 31, 2023.

(51) Int. Cl. G09G 3/34

(52) U.S. Cl. CPC G09G 3/344; G09G 2320/0209; G09G 2320/0257

(57) ABSTRACT

Disclosed are a display panel, a driving method thereof, and a display apparatus. The display panel has a plurality of first region groups arranged in a first direction and extending in a second direction. The first region group internally includes a plurality of first signal lines arranged in the first direction. A non-display region includes: a plurality of second signal lines, and a plurality of first multiplexers in one-to-one correspondence with the plurality of first region groups and sharing the plurality of second signal lines. The first multiplexers are connected to the first signal lines in the corresponding first region groups one to one. The first signal lines are electrically connected to pixel sub-electrodes in pixels arranged in the second direction.

### CROSS-REFERENCE TO RELATED APPLICATIONS

The present application is a continuation application of International Application No. PCT/CN2023/110306, filed Jul. 31, 2023, the entire contents of which are incorporated by reference in the present application.

### TECHNICAL FIELD

The present disclosure relates to the technical field of electrophoretic display, in particular to a display panel, a driving method thereof, and a display apparatus.

### BACKGROUND

In the field of electrophoretic display, in order to realize a transverse electric field to drive electrophoretic particles, it is necessary to configure n (n≥2) pixel sub-electrodes for each pixel and provide different voltages for each pixel sub-electrode, so as to generate a transverse potential difference to drive the electrophoretic particles to do a transverse migration, and the pixel sub-electrodes and a common electrode will also have a potential difference, which may drive the electrophoretic particles to do a longitudinal migration at the same time.

However, on the one hand, the number of the pixel sub-electrodes that need to be configured for each pixel is greater than or equal to 2 and different voltages are needed, making it necessary to provide greater than or equal to 2 data signals for each pixel, which results in a higher number of signal lines in an electrophoretic display panel and more driving chips needing to be configured. On the other hand, when the electrophoretic particles are driven, a later-frame image is prone to erase an earlier-frame image, resulting in an afterimage on an image.

In view of this, how to reduce the generation of the afterimage while reducing the number of the driving chips in the electrophoretic display panel has become an urgent technical problem.

### SUMMARY

Embodiments of the present disclosure provide a display panel, a driving method thereof, and a display apparatus, for solving the above problem existing in the prior art.

In a first aspect, in order to solve the above technical problem, an embodiment of the present disclosure provides a display panel having a display region and a non-display region surrounding the display region. The display region has a plurality of first region groups arranged in a first direction. The first region groups extend in a second direction. Each of the first region groups have at least one region disposed in the second direction. The first direction intersects with the second direction. The first region groups internally include a plurality of first signal lines arranged in the first direction, and a plurality of pixels arranged in an array. Each pixel of the plurality of pixels includes a plurality of pixel sub-electrodes, an electrophoretic liquid layer, and a common electrode sequentially stacked on a base substrate. The non-display region includes: a plurality of second signal lines corresponding to the second direction, and a plurality of first multiplexers in one-to-one correspondence with the plurality of first region groups. The plurality of first multiplexers share the plurality of second signal lines. Output ends of the first multiplexers are connected to the first signal lines in the corresponding first region groups one to one. The first signal lines are electrically connected to the pixel sub-electrodes in the pixels arranged in the second direction. The plurality of first multiplexers, under control of a first gating signal, transmit signals on the plurality of second signal lines to the pixel sub-electrodes in the pixels electrically connected to the first signal lines in the corresponding first region groups in a time-sharing manner, so that all the pixel sub-electrodes corresponding to each row of pixels in the corresponding first region groups are simultaneously loaded with corresponding voltages, or all the pixel sub-electrodes corresponding to one scanning line in the display region are simultaneously loaded with corresponding voltages.

In a possible implementation, each of the first multiplexers includes: a plurality of first thin film transistors in one-to-one correspondence with the plurality of first signal lines. Each of the first thin film transistors includes a first control electrode, a first electrode and a second electrode, and each second electrode is connected to one of the first signal lines in the corresponding first region groups.

In a possible implementation, the first control electrodes of all the first thin film transistors in the first multiplexer are connected to the same first control line, and the first electrodes of all the first thin film transistors in the first multiplexer are connected to the different second signal lines respectively. The first electrodes of the first thin film transistors located at the same relative position in the corresponding first multiplexers of the plurality of first multiplexers are connected to one first signal line. The non-display region includes the first control line.

In a possible implementation, the first control electrodes in the first multiplexer are connected to different first control lines respectively, and all the first electrodes in the first multiplexer are connected to one second signal line. The first control electrodes of the first thin film transistors located at the same relative position in the plurality of first multiplexers are connected to one first control line. The non-display region includes the first control line.

In a possible implementation, if the first region groups include a plurality of regions arranged in the second direction, the display region further internally includes a plurality of third signal lines arranged in the second direction, and the third signal lines are electrically connected to the pixel sub-electrodes in the pixels arranged in the first direction. The non-display region further includes: a plurality of fourth signal lines corresponding to the first direction, and a plurality of second multiplexers. The second multiplexers correspond to second region groups. The second region groups consist of a plurality of regions located at the same arrangement position in each first region group of the plurality of first region groups. The plurality of second multiplexers share the plurality of fourth signal lines. Output ends of the second multiplexers are connected to the third signal lines in the second region groups one to one. The plurality of second multiplexers, under control of a second gating signal, transmit signals on the plurality of fourth signal lines into the corresponding second region groups in a time-sharing manner, and in conjunction with the first gating signal corresponding to the plurality of first multiplexers, cause all the pixel sub-electrodes corresponding to each row of pixels in the first region groups to be simultaneously loaded with corresponding voltages, or cause all the pixel sub-electrodes corresponding to one scanning line in the display region to be simultaneously loaded with corresponding voltages.

In a possible implementation, each of the second multiplexers include: a plurality of second thin film transistors in one-to-one correspondence with the third signal lines in the second region groups. Each of the second thin film transistors includes a second control electrode, a third electrode and a fourth electrode, and each fourth electrode is connected to one of the third signal lines in the corresponding second region groups.

In a possible implementation, the second control electrodes of all the second thin film transistors in the second multiplexers are connected to one second control line, and the fourth electrodes of all the second thin film transistors in the second multiplexer are connected to the different third signal lines respectively. The third electrodes of the second thin film transistors located at the same relative position in the corresponding second multiplexers of the plurality second multiplexers are connected to one fourth signal line. The non-display region includes the second control line.

In a possible implementation, the second control electrodes in the second multiplexer are connected to different second control lines respectively, and all the third electrodes in the second multiplexer are connected to one fourth signal line. The fourth electrodes of the second thin film transistors located at the same relative position in the plurality of second multiplexers are connected to the different third signal lines. The non-display region includes the second control lines.

In a possible implementation, the non-display region further includes: a scanning driving circuit and a data driving circuit. When the first signal lines are data lines, the second signal lines are connected between the data driving circuit and the corresponding first multiplexers. When the first signal lines are scanning lines, the second signal lines are connected between the scanning driving circuit and the corresponding first multiplexers. If the first region groups include the plurality of regions, when the first signal lines are one of the data lines or the scanning lines and the second signal lines are the other of the data lines or the scanning lines, the second signal lines are connected between one of the data driving circuit or the scanning driving circuit and the corresponding first multiplexers, and the fourth signal lines are connected between the other of the data driving circuit and the scanning driving circuit or the corresponding second multiplexers.

In a possible implementation, the non-display region further includes a first control circuit and a second control circuit. The first control lines are connected between the first control circuit and the corresponding first multiplexers. The second control lines are connected between the second control circuit and the corresponding second multiplexers. The first control circuit and the second control circuit include the scanning driving circuit and the data driving circuit.

In a possible implementation, each of the pixels further includes: a plurality of third thin film transistors in one-to-one correspondence with the plurality of pixel sub-electrodes. Each of the third thin film transistors each includes a third control electrode, a fifth electrode and a sixth electrode, and each sixth electrode is connected to the corresponding pixel sub-electrode. If the first region group has one region and the first signal lines are the scanning lines, the third control electrodes of the plurality of third thin film transistors are electrically connected to the different first signal lines, and the fifth electrodes of the plurality of third thin film transistors are connected to one data line. If the first region group has one region and the first signal lines are the data lines, the third control electrodes of the plurality of third thin film transistors are electrically connected to one scanning line, and the fifth electrodes of the plurality of third thin film transistors are connected to the different first signal lines. If the first region group has the plurality of regions, the third control electrodes of the third thin film transistors are electrically connected to the scanning lines, and the fifth electrodes of the third thin film transistors are connected to the data lines.

In a possible implementation, the pixels further include a plurality of charged particles. The plurality of charged particles include: a plurality of first color charged particles, and a plurality of second color charged particles electrically opposite to the first color charged particles.

In a second aspect, an embodiment of the present disclosure provides a driving method based on the display panel in the first aspect, including: loading voltages corresponding to corresponding rows of pixel sub-electrodes simultaneously row by row in a display region; or, controlling all pixel sub-electrodes corresponding to each row of pixels in each first region group of the plurality of first region groups contained in the display region to be loaded with corresponding voltages simultaneously.

In a possible implementation, the controlling all pixel sub-electrodes corresponding to each row of pixels in each first region group of the plurality of first region groups contained in the display region to be loaded with corresponding voltages simultaneously includes: loading, one by one, all the pixel sub-electrodes contained in each row of pixels in the first region groups corresponding to first multiplexers with corresponding voltages simultaneously until the voltages corresponding to all the pixel sub-electrodes corresponding to the last row of pixels in the corresponding first region groups are loaded; and loading the voltages of the pixel sub-electrodes corresponding to the next first region group after loading the voltages corresponding to all the pixel sub-electrodes in one first region group every time until the voltages corresponding to all the pixel sub-electrodes in the last first region group are loaded.

In a possible implementation, the controlling all pixel sub-electrodes corresponding to each row of pixels in each first region group of the plurality of first region groups contained in the display region to be loaded with corresponding voltages simultaneously includes: controlling, row by row, all the pixel sub-electrodes in the corresponding rows of pixels in all the first region groups in the same one pixel row to be loaded with corresponding voltages simultaneously until the voltages of the pixel sub-electrodes of the last row of pixels are loaded.

In a third aspect, an embodiment of the present disclosure provides a display apparatus including the display panel in the first aspect.

### BRIEF DESCRIPTION OF FIGURES

FIG. 1 is a schematic structural diagram of a display panel provided by embodiments of the present disclosure.

FIG. 2 is a schematic structural diagram of a pixel in FIG. 1 provided by embodiments of the present disclosure.

FIG. 3 is a schematic structural diagram of another pixel provided by embodiments of the present disclosure.

FIG. 4 is a timing chart provided by embodiments of the present disclosure.

FIG. 5 is another timing chart provided by embodiments of the present disclosure.

FIG. 6 is a schematic structural diagram of a first multiplexer provided by embodiments of the present disclosure.

FIG. 7 is a schematic structural diagram of a display panel provided by embodiments of the present disclosure.

FIG. 8 is a schematic structural diagram of another display panel provided by embodiments of the present disclosure.

FIG. 9-FIG. 11 are schematic diagrams of a pixel provided by embodiments of the present disclosure.

FIG. 12 and FIG. 13 are schematic structural diagrams of another display panel provided by embodiments of the present disclosure.

FIG. 14 is another timing chart provided by embodiments of the present disclosure.

FIG. 15 is a timing chart corresponding to FIG. 13 provided by embodiments of the present disclosure.

FIG. 16-FIG. 19 are schematic structural diagrams of another display panel provided by embodiments of the present disclosure.

FIG. 20 is a schematic structural diagram of a second multiplexer provided by embodiments of the present disclosure.

FIG. 21-FIG. 23 are schematic structural diagrams of another display panel provided by embodiments of the present disclosure.

Reference numerals: base substrate 1, pixel P, pixel sub-electrode 2, electrophoretic liquid layer 3, common electrode 4, reflective layer 1′, insulating layer 2′, pixel sub-electrode 21, first multiplexer 5, first signal line s, second signal line s′, second multiplexer 5′, third signal line l, fourth signal line l′, first direction X, second direction Y, display region AA, non-display region BB, first thin film transistor 51, first control electrode 511, first electrode 512, second electrode 513, second thin film transistor 51′, second control electrode 511′, third electrode 512′, fourth electrode 513′, first control line c, second control line c′, third thin film transistor 6, third control electrode 61, fifth electrode 62, sixth electrode 63, storage capacitor C, common voltage VCOM, scanning driving circuit 7, data driving circuit 8, first control circuit 9, and second control circuit 9′.

### DETAILED DESCRIPTION

Embodiments of the present disclosure provide a display panel, a driving method thereof, and a display apparatus, for solving the above problem existing in the prior art.

In order to make above objectives, features and advantages of the present disclosure more obvious and understandable, the present disclosure will be further described below in conjunction with accompanying drawings and embodiments. However, example implementations can be implemented in a variety of forms and should not be construed as limited to the implementations set forth herein; and on the contrary, providing these implementations makes the present disclosure more comprehensive and complete, and comprehensively communicates the concept of the example implementations to those skilled in the art. In the figures, the same reference numerals represent the same or similar structures, so their repeated description will be omitted. Words expressing positions and directions described in the present disclosure are illustrated by taking the accompanying drawings as examples, but they may also be changed as needed, and all changes are included in the protection scope of the present disclosure. The accompanying drawings of the present disclosure are only used for illustrating relative positional relationships and do not represent true scales.

It is to be noted that specific details are set forth in the following description to facilitate a full understanding of the present disclosure. However, the present disclosure can be implemented in many other ways different from those described here, and those skilled in the art may make similar promotions without violating the connotation of the present disclosure. Therefore, the present disclosure is not limited by specific implementations disclosed below. The specification then describes a preferred implementation of the present application, but the description is intended to illustrate general principles of the present application and is not used for limiting the scope of the present application. The protection scope of the present application shall be as defined in the appended claims.

A display panel, a driving method thereof, and a display apparatus provided by embodiments of the present disclosure are specifically described below in conjunction with the accompanying drawings.

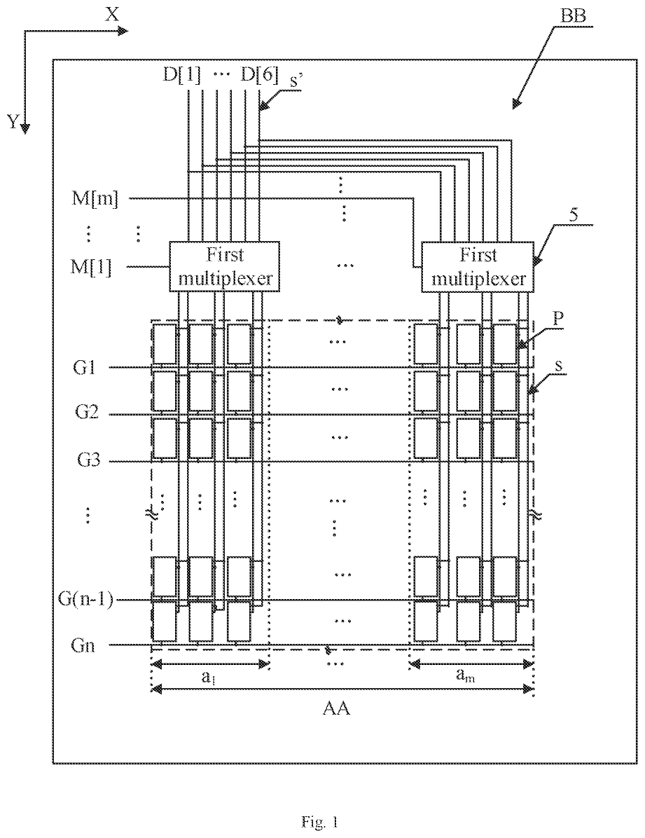

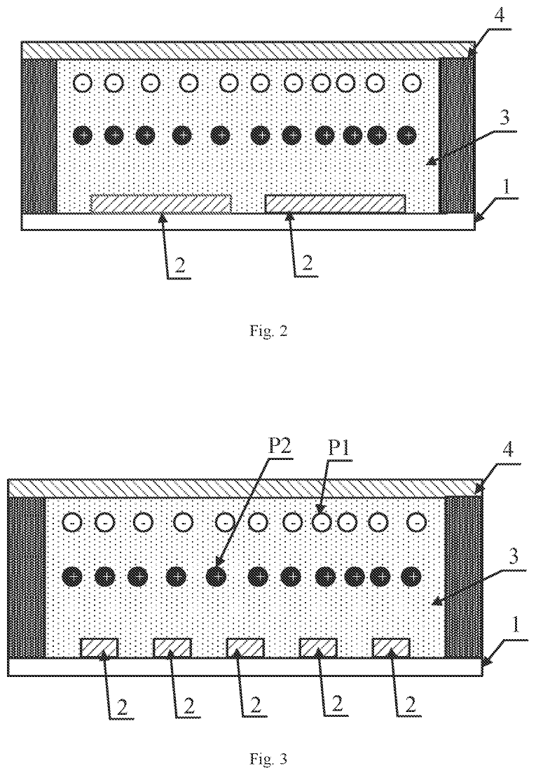

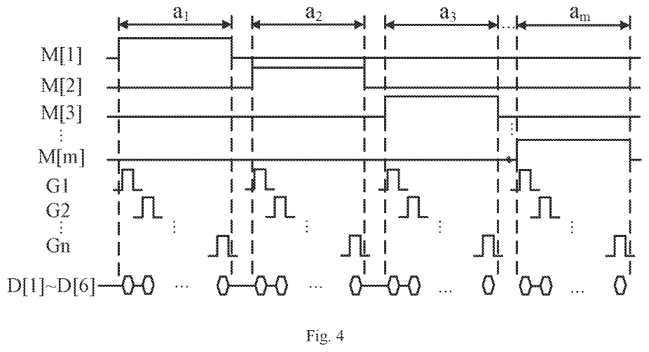

Please refer to FIG. 1-FIG. 3. FIG. 1 is a schematic structural diagram of a display panel provided by an embodiment of the present disclosure. FIG. 2 is a schematic structural diagram of a pixel in FIG. 1 provided by an embodiment of the present disclosure. FIG. 3 is a schematic structural diagram of another pixel provided by an embodiment of the present disclosure.

As shown in FIG. 1, the display panel provided with a display region AA and a non-display region BB surrounding the display region AA. The display region AA has a plurality of first region groups arranged in a first direction X (in FIG. 1, the display region AA is divided into m first region groups, denoted as a₁-aₘ, and each first region group includes 3 columns of pixels P). The first region groups extend in a second direction Y. The first region group has at least one region disposed in the second direction Y. The first direction X intersects with the second direction Y. The first direction is an extension direction of one of a scanning line and a data line. The second direction is an extension direction of the other of the scanning line and the data line. The first region group internally includes a plurality of first signal lines s arranged in the first direction X, and a plurality of pixels P arranged in an array. As shown in FIG. 2, a pixel P includes a plurality of pixel sub-electrodes 2, an electrophoretic liquid layer 3, and a common electrode 4 sequentially stacked on a base substrate 1. Each pixel sub-electrode 2 of the plurality of pixel sub-electrodes 2 is independently controlled.

For example, a pixel electrode of the pixel P in FIG. 2 includes 2 pixel sub-electrodes 2, and a pixel P in FIG. 3 includes 5 pixel sub-electrodes 2. An example is shown in FIG. 1 in which the first signal lines s are data lines and the first region group has one region, and one pixel P corresponds to 2 pixel sub-electrodes 2. In FIG. 1, the pixel sub-electrodes 2 connected to the same one first signal line s have the same relative position in each pixel of a column of pixels P, such as all being a column of pixel sub-electrodes 2 located on a left side or a right side in the same one column of pixels P in FIG. 2.

The non-display region BB includes: a plurality of second signal lines s′ corresponding to the second direction, and a plurality of first multiplexers 5 in one-to-one correspondence with the plurality of first region groups. The plurality of first multiplexers 5 share the plurality of second signal lines s′. Output ends of the first multiplexers 5 are connected to the first signal lines in the corresponding first region groups one to one. The first signal lines s are electrically connected to the pixel sub-electrodes 2 in the pixels arranged in the second direction Y.

The plurality of first multiplexers 5, under control of a first gating signal, transmit signals on the plurality of second signal lines to the pixel sub-electrodes in the pixels electrically connected to the first signal lines s in the corresponding first region groups in a time-sharing manner, so that all the pixel sub-electrodes 2 corresponding to each row of pixels P in the corresponding first region groups are simultaneously loaded with corresponding voltages, or all the pixel sub-electrodes 2 corresponding to the same scanning line in the display region AA are simultaneously loaded with corresponding voltages.

In FIG. 1, the first region group has one region, and an arrangement direction of the plurality of first region groups is the extension direction of the scanning line (i.e., the first direction X). The corresponding first signal lines s are data lines. One first region group includes 3 columns of pixels P, each column of pixels P includes 2 columns of pixel sub-electrodes 2, and thus one first region group includes 6 first signal lines s that are arranged in the first direction X and that extend in the extension direction of the data lines (i.e., the second direction Y). Each first multiplexer includes 6 input ends, 6 output ends and 6 control ends. All the first multiplexers in FIG. 1 share 6 second signal lines s′ (for receiving data signals D[1]-D[6]). The output end of each first multiplexer 6 is connected to the 6 first signal lines s in the corresponding first region group. Since the display region AA is divided into m first region groups arranged in the first direction X, the m first region groups correspond to m multiplexers, if each first multiplexer is controlled with a first gating signal, there are m first gating signals (M[1]-M[m]), and the 6 control ends of each first multiplexer are used for receiving the first gating signals (M[1]-M[m]) so as to determine whether to transmit the data signals D[1]-D[6] received from the plurality of second signal lines s′ to the correspondingly connected plurality of first signal lines s. This makes it possible to provide corresponding data signals for the data lines in the display region AA by means of the 6 second signal lines s′, which can effectively reduce the need for a source driving circuit and reduce a cost.

Please continue to refer to FIG. 2 and FIG. 3. In some embodiments, the pixel P further includes a plurality of charged particles. The plurality of charged particles include: a plurality of first color charged particles P1, and a plurality of second color charged particles P2 electrically opposite to the first color charged particles P1.

As shown in FIG. 2, the pixel P further includes a reflective layer 1′ located between the base substrate 1 and the plurality of pixel sub-electrodes 2. The reflective layer 1′ is used for concentrating the second color (e.g., black) charged particles on the pixel sub-electrodes 2 and white charged particles on an upper surface 4 when a first color (e.g., white, which may be referred to as a white state) is displayed, thereby increasing reflectivity.

The reflective layer 1′ may be a metallic reflective layer or a non-metallic reflective layer. When the reflective layer 1′ is the metallic reflective layer, the pixel P further includes an insulating layer 2′ located between the reflective layer 1′ and the plurality of pixel sub-electrodes 2, as shown in FIG. 3.

The first color charged particles P1 may be, for example, negatively charged white charged particles, and the second color charged particle P2 may be positively charged black charged particles, or vice versa. The first color charged particles P1 may be, for example, negatively charged white charged particles, and the second color charged particles P2 may be positively charged blue charged particles, or vice versa. The first color charged particles P1 may be, for example, negatively charged red charged particles, and the second color charged particles P2 may be positively charged black charged particles, or vice versa. In a screenshot, the first color charged particles P1 and the second color charged particles P2 are of different colors, and the specific colors are not limited here.

Please refer to FIG. 4 which is a timing chart provided by an embodiment of the present disclosure.

It is assumed that there are n scanning lines in the display region AA, and each scanning line is connected to one row of pixels P. In FIG. 4, in a first time duration, the first multiplexer 5 corresponding to the first region group a₁ is gated on by setting M[1] to a high level. The first time duration includes n scanning time durations corresponding to each scanning line. By sequentially turning on the scanning lines G1-Gn and loading the data signals D[1]-D[6] of the corresponding rows at the same time as each scanning line is turned on (a hexagon in FIG. 4 represents D[1]-D[6], and data represented by D[1]-D[6] in different scanning time durations may be the same or different), after turning on the scanning line Gn and loading the corresponding data signals D[1]-D[6], data writing to the first region group a₁ is completed. After that, M[2]-M[m] are set to a high level sequentially, and the data signals D[1]-D[6] of the corresponding rows of pixels P are written row by row sequentially in the rest of first region groups, thereby completing writing of a frame of image of the entire display region AA. Since all the pixel sub-electrodes 2 in corresponding pixel rows in each first region group are loaded with respective corresponding voltages simultaneously in an above processing process, crosstalk of data in earlier and later frames can be effectively prevented, and the occurrence of afterimages can be reduced.

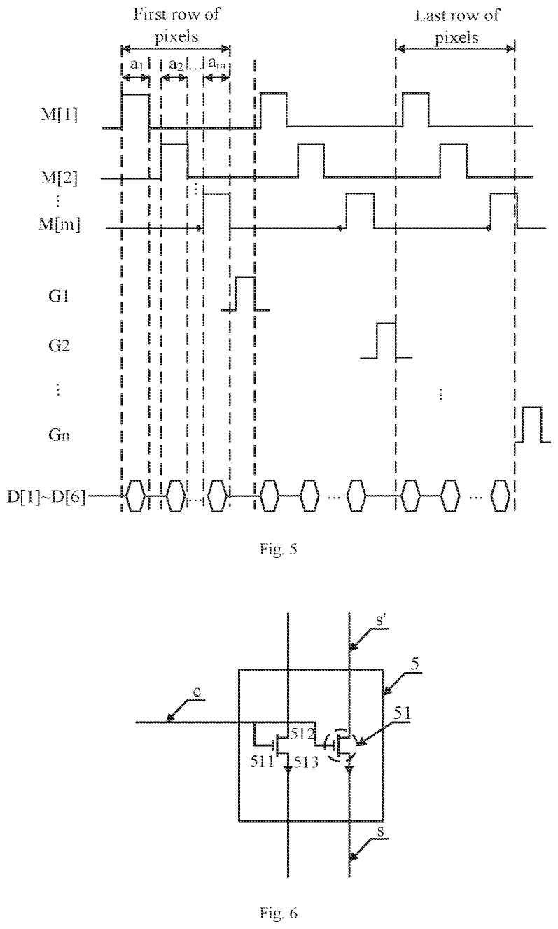

Please refer to FIG. 5 which is another timing chart provided by an embodiment of the present disclosure.

It is assumed that there are n scanning lines in the display region AA, and each scanning line is connected to one row of pixels P. In a first time duration, the first multiplexer 5 corresponding to the first region group a₁ is gated on by setting M[1] to a high level, and data signals D[1]-D[6] of the first row of pixels P in the first region group a₁ are loaded onto the corresponding first signal line s. In a second time duration, the first multiplexer 5 corresponding to the first region group a₂ is gated on by setting M[2] to a high level, and data signals D[1]-D[6] of the first row of pixels P in the first region group a₂ are loaded onto the corresponding first signal line s. By analogy, data signals D[1]-D[6] of the first row of pixels P in the corresponding first region group are loaded onto the corresponding first signal line s first region group by first region group until the data signals D[1]-D[6] of the first row of pixels P in the last first region group are loaded onto the corresponding first signal line s, and then a scanning signal of the first row of pixels P is turned on to write data of the first row of pixels P. After that, data of each row of pixels P is written row by row, and a data writing manner of each row of pixels P is the same as that of the first row of pixels P, which will not be repeated here, until data of the last row of pixels P is written. Since the data in each row of pixels P in the above scheme is written simultaneously, the voltage corresponding to each pixel sub-electrode 2 in each row of pixels P is loaded simultaneously, thus crosstalk of data in earlier and later frames can be effectively prevented, and the occurrence of afterimages can be reduced.

In the embodiments provided by the present disclosure, the plurality of first multiplexers 5 are disposed in the non-display region BB, each first multiplexer 5 is made to correspond to one first region group in the display region AA and to be connected to a plurality of first signal lines s arranged in the corresponding first region group in the first direction X and extending in the second direction Y, the plurality of first multiplexers 5 share the plurality of second signal lines s′, thus the plurality of first multiplexers 5, when under control of a first gating signal, may transmit signals on the plurality of second signal lines s′ to the first signal lines s in the corresponding first region groups in a time-sharing manner, so that the plurality of pixel sub-electrodes 2 corresponding to each row of pixels P in the corresponding first region groups are simultaneously loaded with corresponding voltages, or all the pixel sub-electrodes 2 of the pixels P corresponding to the same scanning line in the display region AA are simultaneously loaded with corresponding voltages. Therefore, the number of the second signal lines s′ connected to the driving circuit can be reduced, the need for the driving circuit and the production cost can be reduced, crosstalk of data in earlier and later frames can also be effectively prevented, and the occurrence of afterimages can be reduced.

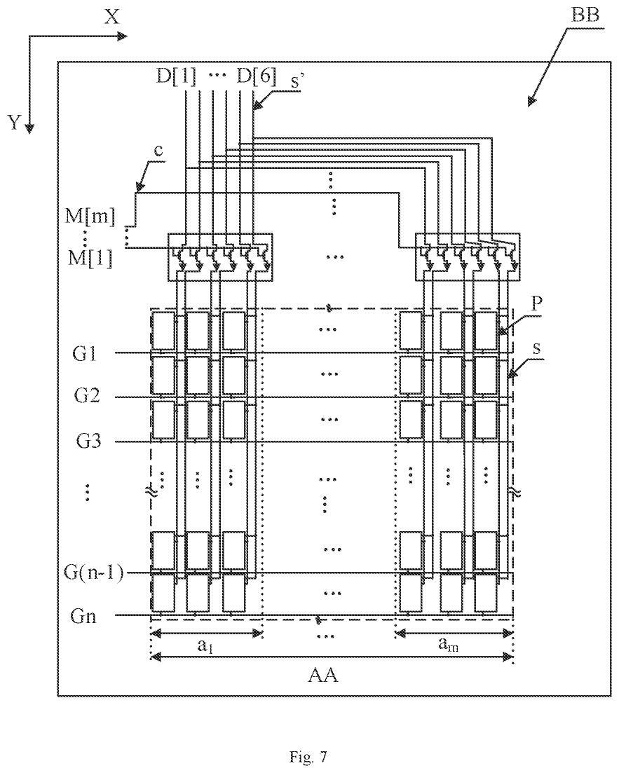

Please refer to FIG. 6 and FIG. 7. FIG. 6 is a schematic structural diagram of a first multiplexer provided by an embodiment of the present disclosure. FIG. 7 is a schematic structural diagram of a display panel provided by an embodiment of the present disclosure.

As shown in FIG. 6, the first multiplexer 5 includes: a plurality of first thin film transistors 51 in one-to-one correspondence with the first signal lines s in the first region groups.

Each of the first thin film transistors 51 includes a first control electrode 511, a first electrode 512 and a second electrode 513, and each second electrode 513 is connected to one of the first signal lines s in the corresponding first region groups.

The first thin-film transistors 51 may be N-type thin-film transistors or P-type thin-film transistors. The figures of the present disclosure all take the first thin film transistors 51 being the N-type thin film transistors as examples. If the first thin film transistors are changed to the P-type thin film transistors, only a slight change in a connection manner is required, so it will not be repeated herein.

When the display panel adopts the first multiplexer 5 shown in FIG. 6, the structure of the display panel is shown in FIG. 7. The first control electrodes 511 of all the first thin film transistors 51 in the first multiplexer 5 are connected to the same first control line c, and each first electrode 512 is connected to the different second signal line s′. The first electrodes 512 of the first thin film transistors 51 located at the same position in the plurality of first multiplexers 5 are connected to the same first signal line s. The non-display region BB includes the first control line c. The structure of the display panel shown in FIG. 7 may be controlled by a sequential control manner in aforementioned FIG. 4 or FIG. 5, which will not be repeated.

In the embodiment provided by the present disclosure, by making the first control electrodes 511 of all the first thin film transistors 51 in the first multiplexer 5 connected to the same first control line c, it is possible to control simultaneous conduction of all the first thin film transistors 51 in the first multiplexer 5 by means of the same first gating signal, so that signals on the second signal lines s′ connected to all the first electrodes 512 in the first multiplexer 5 may be simultaneously transmitted to the corresponding first signal lines s. In addition, it is possible to make the number of the second signal lines s′ connected to the plurality of first multiplexers 5 the same as the number of the first thin film transistors 51 contained in a single first multiplexer 5, so that the number of the second signal lines s′ connected to driving circuits can be effectively reduced, and then the driving circuits required for the display panel are reduced, thus reducing the production cost.

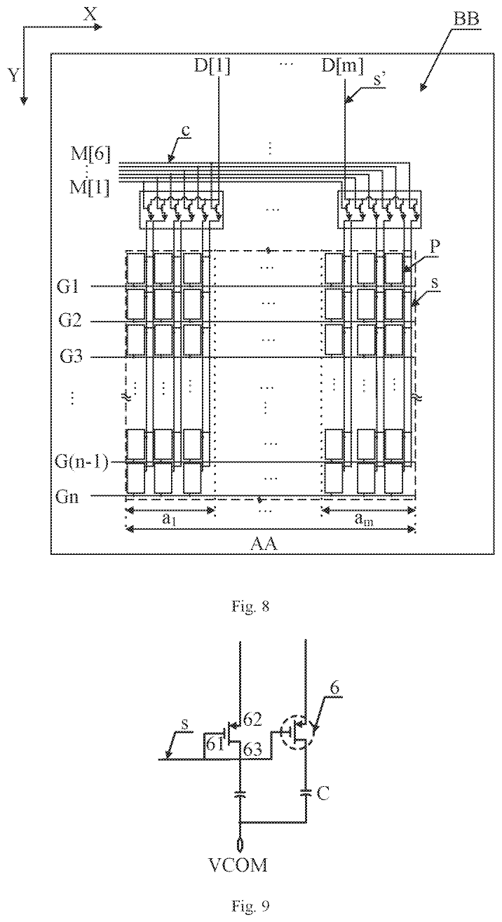

Please refer to FIG. 8 which is a schematic structural diagram of another display panel provided by an embodiment of the present disclosure.

Each first control electrode 511 in the first multiplexer 5 is connected to a different first control line c, and all the first electrodes 512 are connected to the same second signal line s′. The first control electrodes 511 of the first thin film transistors 51 located at the same relative position in the plurality of first multiplexers 5 are connected to the same first control line. The non-display region BB includes the first control line.

The display panel shown in FIG. 8 may be controlled by a sequential control manner similar to that of FIG. 5. It is assumed that there are n scanning lines in the display region AA, and each scanning line is connected to one row of pixels P. In a first time duration, the first thin film transistor 51 on a left side in each first multiplexer 5 corresponding to the first region groups a₁-aₘ is gated on by setting M[1] to a high level, and data signals D[1]-D[6] are loaded onto the first signal lines s in the first row of pixels P connected to the first electrodes 512 of the gated-on first thin film transistors 51. In a second time duration, the second thin film transistor 51 on the left side in each first multiplexer 5 corresponding to the first region groups a₁-aₘ is gated on by setting M[2] to a high level, and data signals D[1]-D[6] are loaded onto the first signal lines s in the first row of pixels P connected to the first electrodes 512 of the gated-on first thin film transistors 51. By analogy, all displayed data signals of the first row of pixels P are loaded onto the corresponding first signal lines s, and then a scanning signal of the first row of pixels P is turned on to write data of the first row of pixels P. After that, data of each row of pixels P is written row by row, and a data writing manner of each row of pixels P is the same as that of the first row of pixels P, which will not be repeated here, until data of the last row of pixels P is written. Since the data in each row of pixels P in the above scheme is written simultaneously, the voltage corresponding to each pixel sub-electrode 2 in each row of pixels P is loaded simultaneously, thus crosstalk of data in earlier and later frames can be effectively prevented, and the occurrence of afterimages can be reduced.

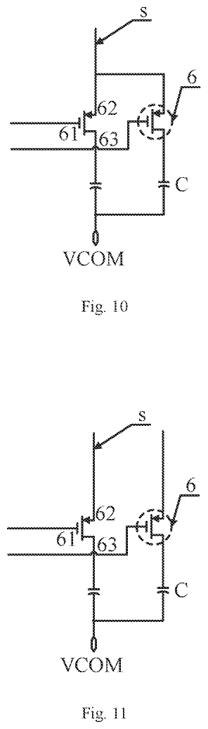

Please refer to FIG. 9-FIG. 11 which are schematic diagrams of a pixel provided by an embodiment of the present disclosure.

Each of the pixels P further include: a plurality of third thin film transistors 6 in one-to-one correspondence with the plurality of pixel sub-electrodes 2.

Each of the third thin film transistor includes a third control electrode 61, a fifth electrode 62 and a sixth electrode 63, and each sixth electrode 63 is connected to the corresponding pixel sub-electrode 2. One pixel sub-electrode 2 and the common electrode 4 form a storage capacitor C, wherein the common electrode 4 is used for carrying a common voltage VCOM.

If the first region group has one region and the first direction is the extension direction of the scanning lines, as shown in FIG. 9, the first signal lines s are data lines, the fourth control electrodes 61 of the plurality of third thin film transistors 6 are electrically connected to the same scanning line, and the fifth electrodes 62 of the plurality of third thin film transistors 6 are connected to different first signal lines s. Under this pixel structure, the structure of the display panel is shown in FIG. 7 or FIG. 8.

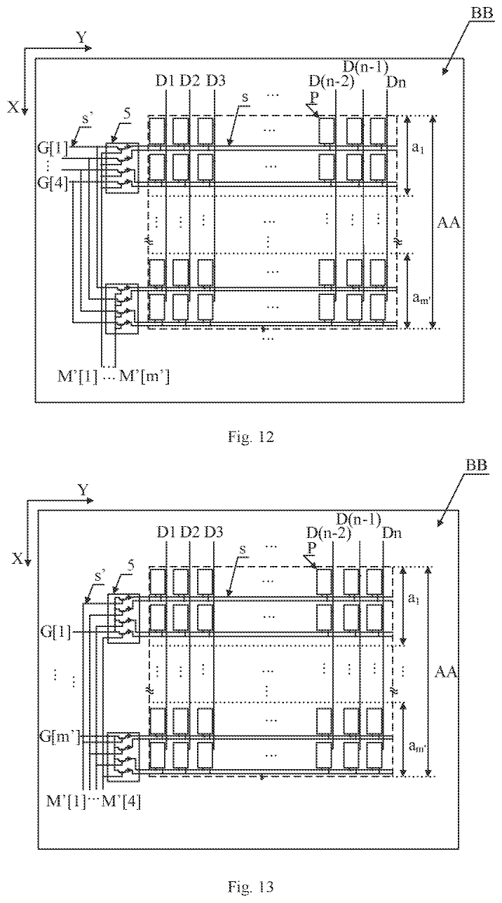

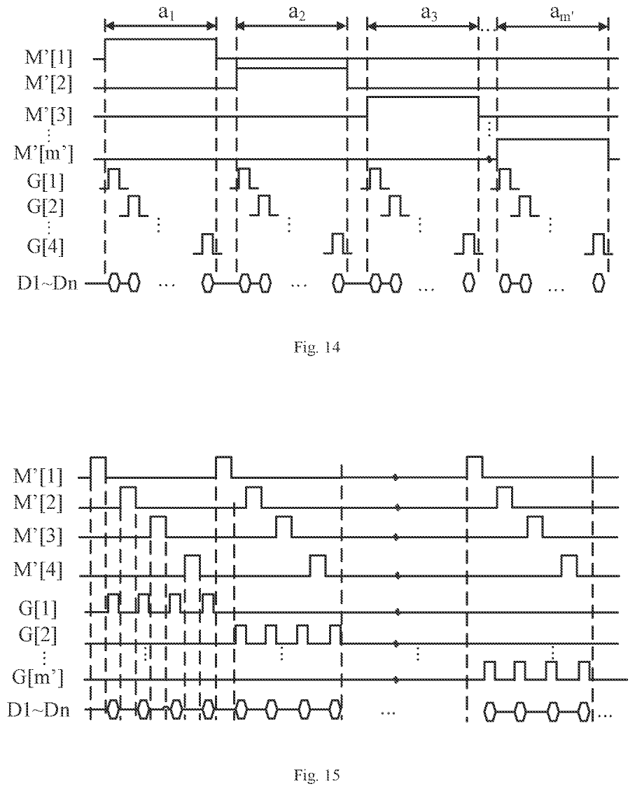

If the first region group has one region and the first direction is the extension direction of the data lines, the first signal lines s are scanning lines, as shown in FIG. 10, the third control electrodes 61 of the plurality of third thin film transistors 6 are electrically connected to different first signal lines s, and the fifth electrodes 62 of the plurality of third thin film transistors 6 are connected to the same data line. Please refer to FIG. 12 and FIG. 13 which are schematic structural diagrams of another display panel provided by an embodiment of the present disclosure. The pixels P in FIG. 12 and FIG. 13 adopt the pixel structure shown in FIG. 10, and the display region AA is divided into m′ first region groups (i.e., m′ regions) in the second direction Y (i.e., the extension direction of the data lines). Each region includes 2*n pixels P, and each pixel P includes 2 pixel sub-electrodes 2. A sequential control manner that may be adopted by the display panel shown in FIG. 12 is shown in FIG. 14, which is another timing chart provided by an embodiment of the present disclosure. The timing charts shown in FIG. 14 and FIG. 4 are similar.

In FIG. 14, in a first time duration, the first multiplexer 5 corresponding to the region a₁ is gated on by setting M′[1] to a high level. The first time duration includes 4 scanning time durations. By sequentially loading scanning signals G[1]-G[4] on each second signal line s′ in the first region group a₁ onto the corresponding first signal line s, and loading data signals D1-Dn of the corresponding row at the same time of loading the scanning signal every time (a hexagon in FIG. 14 represents D1-Dn, and data represented by D[1]-D[4] in different scanning time durations may be the same or different), data writing to the first region group a₁ may be completed. After that, M′[2]-M′[m] are set to a high level sequentially, and the data signals D1-Dn of the pixel sub-electrodes 2 connected to the corresponding first signal line s are written row by row in the corresponding first region group, thereby completing writing of a frame of image of the entire display region AA. If row writing time corresponding to the first signal line s in the above display panel is H, and each pixel P includes i pixel sub-electrodes 2, then a maximum writing time difference between the i pixel sub-electrodes 2 in the same pixel P is at most i*H. For electrophoretic display, a writing time difference between the rows of the pixel sub-electrodes 2 in the same pixel P has a negligible impact on particle electrophoresis, and basically does not exacerbate an afterimage phenomenon. Therefore, the above scheme can also effectively prevent crosstalk of data in the earlier and later frames and reduce the occurrence of afterimages.

Please refer to FIG. 15 which is a timing chart corresponding to FIG. 13 provided by an embodiment of the present disclosure.

In FIG. 15, voltages corresponding to the pixel sub-electrodes 2 in the corresponding first region groups are loaded first region group by first region group, wherein voltages corresponding to all the pixel sub-electrodes 2 in the corresponding rows are loaded simultaneously pixel sub-electrode row by pixel sub-electrode row in each first region group, and one pixel sub-electrode row is pixel sub-electrodes 2 connected to the same first signal line s. In the above scheme, since a time interval for loading the corresponding voltages to the pixel sub-electrode 2 inside each pixel P is very short and negligible, the phenomenon of afterimages appearing in earlier and later bright frame images can be effectively reduced.

If the first region group has a plurality of regions, the first direction X is the extension direction of one of the data lines and the scanning lines, the second direction Y is the extension direction of the other of the data lines and the scanning lines, and the corresponding first signal lines are one of the data lines and the scanning lines. At this time, the third control electrodes 61 of the third thin-film transistors 6 are electrically connected to the scanning lines (if the first signal lines s are scanning lines, then the third control electrodes 61 are electrically connected to the first signal lines s), the fifth electrodes 62 of the third thin film transistors 6 are connected to the data lines (the first signal lines s are electrically connected to the fifth electrodes 62 if the first signal lines s are data lines), as shown in FIG. 11, if the first signal lines s are data lines, the third control electrodes 61 of the third thin film transistors 6 are electrically connected to the corresponding scanning lines, and the fifth electrodes 62 of the third thin film transistors 6 are electrically connected to the corresponding second signal lines s′ via the connected first signal lines s.

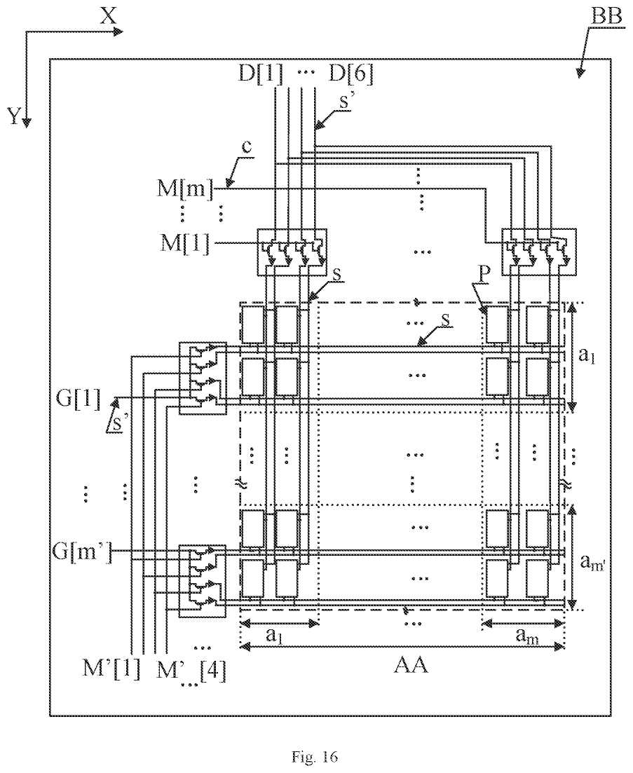

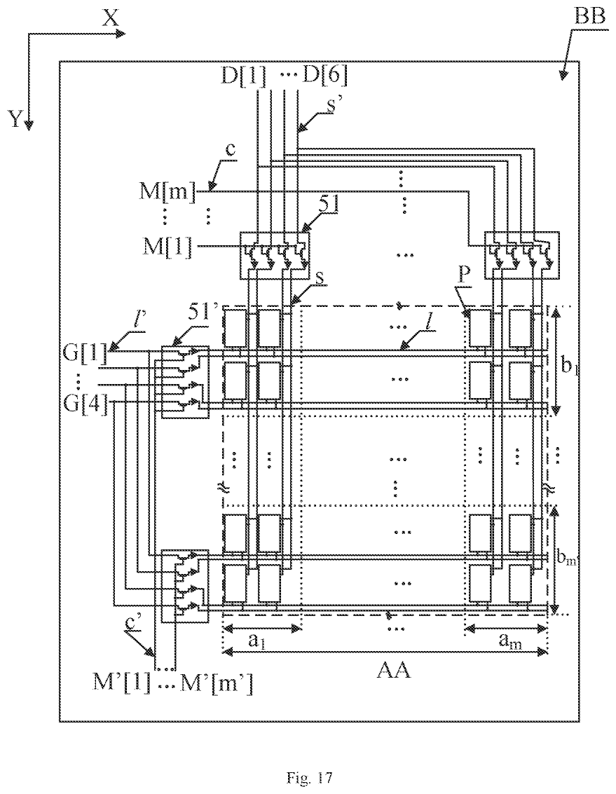

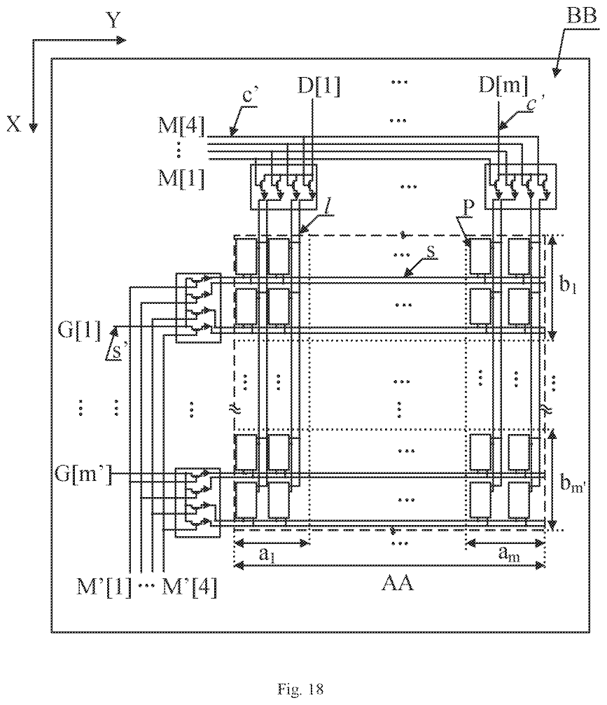

Please refer to FIG. 16-FIG. 19 which are schematic structural diagrams of another display panel provided by an embodiment of the present disclosure. If the first region groups include a plurality of regions arranged in the second direction Y, the display region AA further includes a plurality of third signal lines l arranged in the second direction Y, and the third signal lines l are electrically connected to the pixel sub-electrodes 2 in the pixels arranged in the first direction X.

The non-display region BB further includes: a plurality of fourth signal lines l corresponding to the first direction X, and a plurality of second multiplexers 5′. The second multiplexers 5′ correspond to second region groups. The second region groups consist of a plurality of regions located at the same arrangement position in each first region group of the plurality of first region groups. The plurality of second multiplexers 5′ share the plurality of fourth signal lines l. Output ends of the second multiplexers 5′ are connected to the third signal lines in the second region groups one to one. As shown in FIG. 16, the first direction X is an extension direction of the scanning lines. The first signal lines s are data lines. The third signal lines l are scanning lines. The first region group a₁ consists of m′ regions arranged in the second direction Y. The first m regions in the first region group a₁-the first region group aₘ constitute the second region group b₁. By analogy, the m′^{th} m regions in the first region group a₁-the first region group aₘ constitute the second region group bₘ′.

The plurality of second multiplexers 5′, under control of a second gating signal, transmit signals on the plurality of fourth signal lines l into corresponding second region groups in a time-sharing manner, and in conjunction with the first gating signal corresponding to the plurality of first multiplexers 5, cause all the pixel sub-electrodes corresponding to each row of pixels in the first region groups to be simultaneously loaded with corresponding voltages, or cause all the pixel sub-electrodes corresponding to the same scanning line in the display region to be simultaneously loaded with corresponding voltages.

FIG. 16 to FIG. 19 assume that the display region AA is divided into m′*m regions arranged in an array. Each first multiplexer 5 corresponds to one first region group. Each second multiplexer 5′ corresponds to one second region group.

In FIG. 16 and FIG. 17, since the plurality of second signal lines s′ connected to the plurality of first electrodes 512 in each first multiplexer 5 are in one-to-one correspondence with the plurality of first signal lines s connected to the plurality of second electrodes 513 in the first multiplexers 5, and since the plurality of first control electrodes 511 in the first multiplexers 5 are connected to the same first control line c, every time the first multiplexers 5 are turned on, data signals corresponding to all pixel sub-electrodes 2 in a row of pixels P in the corresponding first region group may be simultaneously loaded onto the corresponding second signal lines s′, and in conjunction with the control of the second multiplexers 5′ connected to the corresponding rows, the voltages corresponding to all the pixel sub-electrodes 2 of the same row of pixels P in each region may be loaded simultaneously, thus reducing the impact of data in an earlier-frame image on data in a later-frame image and reducing the afterimage phenomenon.

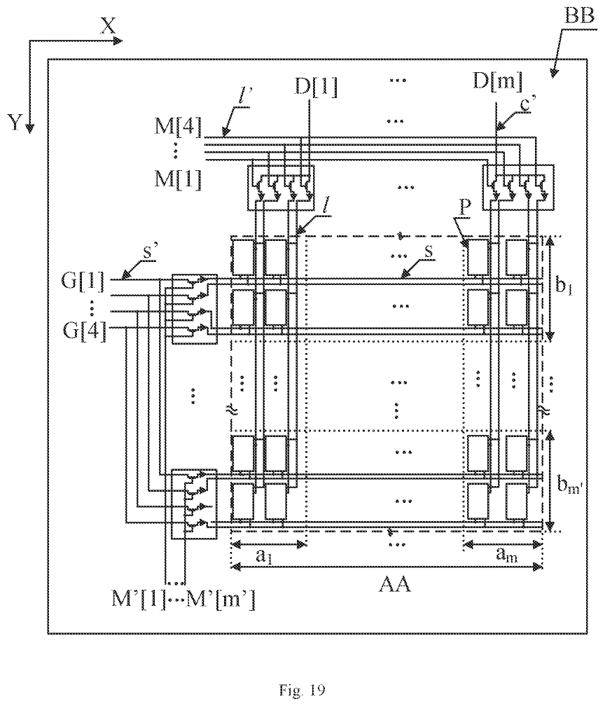

In FIG. 18 and FIG. 19, one second signal line s′ connected to the plurality of first electrodes 512 in each first multiplexer 5 is connected to the plurality of first signal lines s connected to the plurality of second electrodes 513 in the first multiplexers 5, so that the plurality of pixel sub-electrodes 2 in each pixel P share one second signal line. Each pixel sub-electrode 2 corresponds to the first control electrode 511 of the corresponding first thin film transistor 5 in the first multiplexers 5 to be connected to a separate first control line c. In conjunction with the control of the second multiplexers 5′ connected to the corresponding rows, the voltages of each row of pixel sub-electrodes 2 may be loaded simultaneously row by row during displaying, thus reducing the impact of data in an earlier-frame image on data in a later-frame image and reducing the afterimage phenomenon.

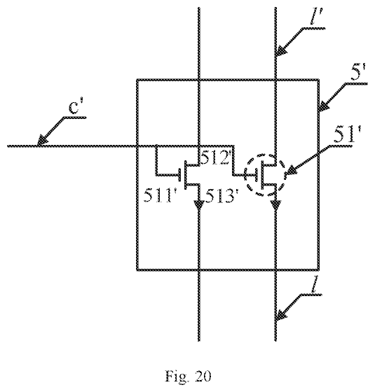

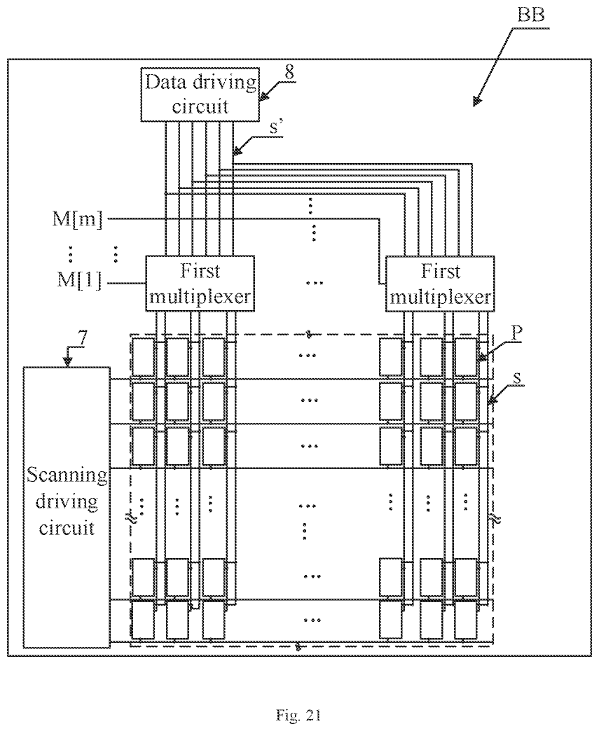

Please refer to FIG. 20 which is a schematic structural diagram of a second multiplexer provided by an embodiment of the present disclosure.

The second multiplexer 5′ includes: a plurality of second thin film transistors 51′ in one-to-one correspondence with the third signal lines l in the second region groups.

The second thin film transistors 51′ each include a second control electrode 511′, a third electrode 512′, and a fourth electrode 513′, and each fourth electrode 513′ is connected to one of the third signal lines l in the corresponding second region groups.

The second thin-film transistors 51′ may be N-type thin-film transistors or P-type thin-film transistors. The figures of the present disclosure all take the second thin film transistors 51′ being the N-type thin film transistors as examples. If the second thin film transistors are changed to the P-type thin film transistors, only a slight change in a connection manner is required, so it will not be repeated herein.

As shown in FIG. 16 and FIG. 17, the second control electrodes 511′ of all the second thin film transistors 51′ in the second multiplexer 5′ are connected to the same second control line c′, and each fourth electrode 513′ in the second multiplexer 5′ is connected to the different third signal line l. The third electrodes 512′ of the second thin film transistors 51′ located at the same relative position in the corresponding second multiplexers 5′ of the plurality second multiplexers 5′ are connected to the same fourth signal line l′. The non-display region includes the second control line c′.

As shown in FIG. 19, each second control electrode 511′ in the second multiplexer 5′ is connected to a different second control line c′, all third electrodes 512′ in the second multiplexer 5′ are connected to the same fourth signal line l′, and the fourth electrodes 513′ of the second thin film transistors 51′ at the same relative position in the plurality of second multiplexers 5′ are connected to different third signal lines l. The non-display region BB includes the second control lines c′.

Please refer to FIG. 21-FIG. 23 which are schematic structural diagrams of another display panel provided by an embodiment of the present disclosure. The non-display region BB in the display panel further includes: a scanning driving circuit 7 and a data driving circuit 8.

The first region group has one region, and when the first signal lines s are data lines, the second signal lines s′ are connected between the data driving circuit 8 and the corresponding first multiplexers 5. As shown in FIG. 21, the plurality of first signal lines s are data lines, the second signal lines s′ are connected between the data driving circuit 8 and the corresponding first multiplexers 5, and the corresponding scanning driving circuit 7 is connected to the corresponding scanning lines.

The first region group has one region, and when the first signal lines s are scanning lines, the second signal lines s′ are connected between the scanning driving circuit 7 and the corresponding first multiplexers 5. As shown in FIG. 21, the plurality of first signal lines s are scanning lines, and the second signal lines s′ are connected between the scanning driving circuit 7 and the corresponding first multiplexers 5. At this time, the data driving circuit 8 is connected to the data lines.

In some embodiments, the first region group has a plurality of regions. The first signal lines s are one of data lines and scanning lines, and the second signal lines s′ are the other of the data lines and the scanning lines. The second signal line s′ are connected between one of the data driving circuit 8 and the scanning driving circuit 7 and the corresponding first multiplexers 5. The fourth signal lines l are connected between the other of the data driving circuit 8 and the scanning driving circuit 7 and the corresponding second multiplexers 5′. As shown in FIG. 23, if the first signal lines s are data lines and the third signal lines l are scanning lines, the second signal lines s′ are connected between the data driving circuit 8 and the first multiplexers 5, the fourth signal lines P′ are connected between the scanning driving circuit 7 and the second multiplexers 5′, vice versa.

Please continue to refer to FIG. 23. The non-display region BB of the display panel further includes a first control circuit 9 and a second control circuit 9′. The first control lines c are connected between the first control circuit 9 and the first multiplexers 5. The second control lines c′ are connected between the second control circuit 9′ and the corresponding second multiplexers 5′.

The first control circuit 9 and the second control circuit 9′ include the scanning driving circuit 7 and the data driving circuit 8.

The first control circuit 9 in FIG. 23 may be the scanning driving circuit 7, the data driving circuit 8, or other circuits.

The second control circuit 9′ in FIG. 23 may be the scanning driving circuit 7, the data driving circuit 8, or other circuits.

In the embodiment provided by the present disclosure, by disposing the first control circuit 9 and the second control circuit 9′ as the scanning driving circuit 7 or the data driving circuit 8, new circuits may not be added, which facilitates material management.

Based on the same inventive concept, an embodiment of the present disclosure provides a driving method based on the above display panel. The driving method includes the following two schemes.

First scheme: voltages corresponding to corresponding rows of pixel sub-electrodes are loaded simultaneously row by row in a display region.

The voltages corresponding to the corresponding rows of pixel sub-electrodes are loaded simultaneously row by row in the display region. When each row of pixel sub-electrodes is loaded and an extension direction of the first region groups is an extension direction of a scanning line, the voltages of the same row of pixel sub-electrodes in the corresponding first region group may be loaded first region group by first region group. When the extension direction of the first region groups is an extension direction of a data line, the voltages of the same row of pixel sub-electrodes in the plurality of the first region groups may be loaded simultaneously. Corresponding sequential control may specifically be set according to a structure of the display panel.

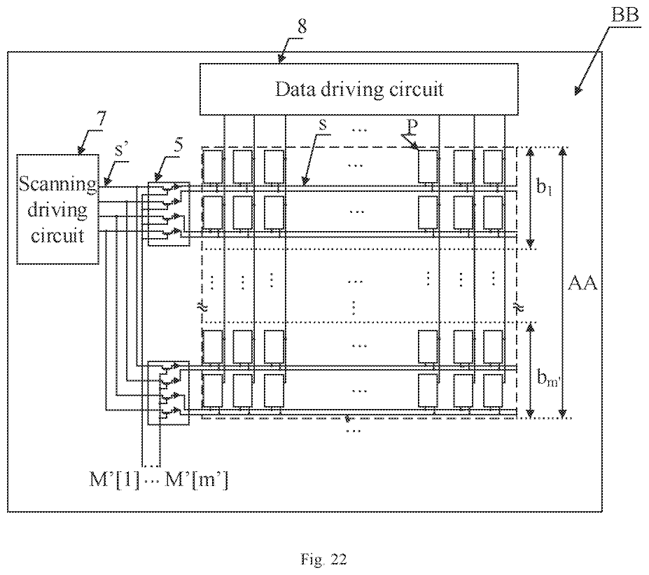

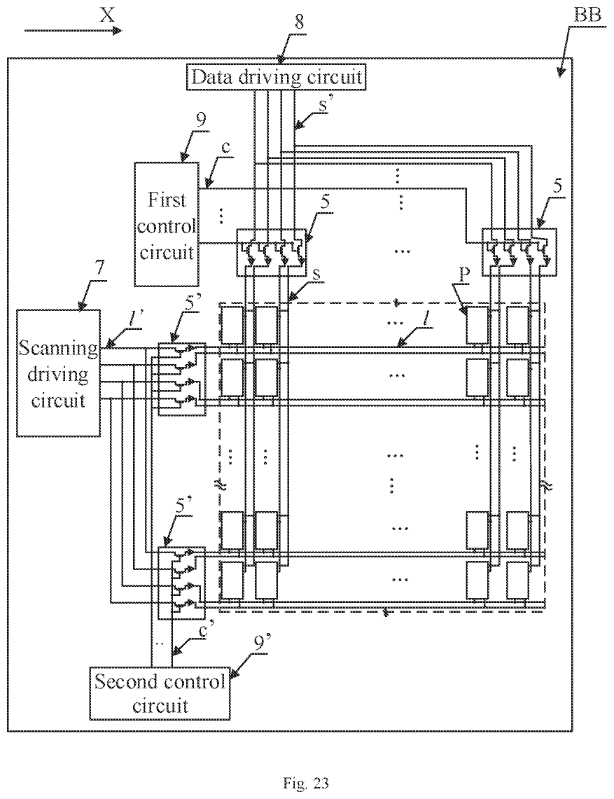

For example, the display panel is shown in FIG. 12 and the sequential control adopts FIG. 14; or, the display panel is shown in FIG. 13 and a timing chart adopts FIG. 15; or, the display panel is shown in FIG. 23 and the timing chart adopts a data writing manner similar to that of FIG. 14; or, the display panel is shown in FIG. 22 and the timing chart adopts a data writing manner similar to that of FIG. 15. All may be realized, and will not be repeated herein.

In the embodiment provided by the present disclosure, by loading voltages corresponding to corresponding rows of pixel sub-electrodes simultaneously row by row in the display region, a maximum writing time difference corresponding to loading the voltages onto the pixel sub-electrodes in each pixel may be controlled within H*i, wherein H is a row writing time difference of the pixel sub-electrodes, and i is a total number of the pixel sub-electrodes contained in the pixels. For electrophoretic display, the row writing time difference has a negligible impact on particle electrophoresis, and basically does not exacerbate an afterimage phenomenon. Therefore, the electrophoretic display panel can effectively reduce the afterimage phenomenon and improve a display effect when the above scheme is adopted for earlier and later frame display.

Second scheme: all the pixel sub-electrodes corresponding to each row of pixels in each first region group of the plurality of first region groups contained in the display region are controlled to be loaded with corresponding voltages simultaneously.

In the embodiment provided by the present disclosure, by controlling all the pixel sub-electrodes corresponding to each row of pixels in each first region group of the plurality of first region groups contained in the display region to be loaded with the corresponding voltages simultaneously, a time difference of loading the voltages onto the pixel sub-electrodes in each pixel is made to be zero, so that afterimages can be effectively prevented in the display of earlier and later frames of images, and the display effect can be improved.

In some embodiments, the controlling all pixel sub-electrodes corresponding to each row of pixels in each first region group of a plurality of first region groups contained in the display region to be loaded with corresponding voltages simultaneously may be implemented in the following manner.

All the pixel sub-electrodes contained in each row of pixels in the first region groups corresponding to first multiplexers are loaded with corresponding voltages simultaneously one by one until the voltages corresponding to all the pixel sub-electrodes corresponding to the last row of pixels in the corresponding first region groups are loaded. For example, in the display panel shown in FIG. 8, m regions extend in the extension direction of the scanning lines, at which time an region may be regarded as a first region group. For another example, in the display panel shown in FIG. 12, m′ regions extend in the extension direction of the data lines, at which time an region can also be regarded as a first region group. For yet another example, the display panel shown in FIG. 18 has m′*m regions, the m regions arranged in the extension direction of the scanning lines may be regarded as a first region group, and the m′ regions arranged in the extension direction of the data lines may be regarded as a second region group. Or the m′ regions arranged in the extension direction of the data lines may be regarded as a first region group, and the m regions arranged in the extension direction of the scanning lines may be regarded as a second region group. Then all the pixel sub-electrodes contained in each row of pixels in the corresponding first region groups may be controlled to be loaded with corresponding voltages simultaneously first region group by first region group until the voltages corresponding to all rows of pixel sub-electrodes in the corresponding first region groups are loaded.

The voltages of the pixel sub-electrodes corresponding to the next first region group are loaded after the voltages corresponding to all the pixel sub-electrodes in one first region group are loaded every time until the voltages corresponding to all the pixel sub-electrodes in the last first region group are loaded.

The first region group consists of one region. For example, when the arrangement direction of the plurality of first region groups is the extension direction of the scanning lines, the display panel is shown in FIG. 7, one region is a first region group, and the timing chart is shown in FIG. 4. Or when the arrangement direction of the plurality of first region groups is the extension direction of the data lines, one region is a first region group, the display panel is shown in FIG. 12, and the timing chart is shown in FIG. 14.

The first region group may also consist of a plurality of regions arranged in the second direction. For example, the display panel is shown in FIG. 19, each column of regions is a first region group, and the timing chart adopts a data writing manner similar to that of FIG. 4. The display panel is shown in FIG. 21, each row of regions is a first region group, and the timing chart adopts a data writing manner similar to that of FIG. 4.

In some other embodiments, the controlling all pixel sub-electrodes corresponding to each row of pixels in each first region group of a plurality of first region groups contained in the display region to be loaded with corresponding voltages simultaneously may further be implemented in the following manner.

All the pixel sub-electrodes in the corresponding rows of pixels in all the first region groups in the same pixel row are controlled to be loaded with the corresponding voltages simultaneously row by row until the voltages of the pixel sub-electrodes of the last row of pixels are loaded. For example, the display panel is shown in FIG. 7, and the timing chart is shown in FIG. 5.

Based on the same inventive concept, an embodiment of the present disclosure provides a display apparatus including the above display panel.

The display apparatus may be a display apparatus such as a liquid crystal display, a liquid crystal display panel, and a liquid crystal television, or a mobile device such as a cell phone, a tablet computer, and a laptop.

Although the preferred embodiments of the present disclosure have been described, those skilled in the art can make additional changes and modifications on these embodiments once they know the basic creative concept. So the appended claims are intended to be construed to include the preferred embodiments and all changes and modifications that fall into the scope of the present disclosure.

Apparently, those skilled in the art can perform various alterations and variations on the present disclosure without departing from the spirit and scope of the present disclosure. Therefore, if these modifications and variations on the present disclosure are within the scope of the claims of the present disclosure and their equivalent technologies, the present disclosure is also intended to contain these alterations and variations.

What is claimed is:

1. A display panel, comprising a display region and a non-display region surrounding the display region, wherein the display region has a plurality of first region groups arranged in a first direction, the first region groups extend in a second direction, each of the first region groups have at least one region disposed in the second direction, the first direction intersects with the second direction, each of the first region groups internally comprises a plurality of first signal lines arranged in the first direction, and a plurality of pixels arranged in an array, and each pixel of the plurality of pixels comprises a plurality of pixel sub-electrodes, an electrophoretic liquid layer, and a common electrode sequentially stacked on a base substrate; the non-display region comprises:
a plurality of second signal lines corresponding to the second direction; and
a plurality of first multiplexers in one-to-one correspondence with the plurality of first region groups, wherein the plurality of first multiplexers share the plurality of second signal lines, output ends of the first multiplexers are connected to the first signal lines in the corresponding first region groups one to one, and the first signal lines are electrically connected to the pixel sub-electrodes in the pixels arranged in the second direction; and
the plurality of first multiplexers, under control of a first gating signal, transmit signals on the plurality of second signal lines to the pixel sub-electrodes in the pixels electrically connected to the first signal lines in the corresponding first region groups in a time-sharing manner, so that all the pixel sub-electrodes corresponding to each row of pixels in the corresponding first region groups are simultaneously loaded with corresponding voltages, or all the pixel sub-electrodes corresponding to one scanning line in the display region are simultaneously loaded with corresponding voltages.

2. The display panel according to claim 1, wherein each of the first multiplexers comprises:
a plurality of first thin film transistors in one-to-one correspondence with the plurality of first signal lines; and
each of the first thin film transistors comprises a first control electrode, a first electrode and a second electrode, and each second electrode is connected to one of the first signal lines in the corresponding first region group.

3. The display panel according to claim 2, wherein the first control electrodes of all the first thin film transistors in the first multiplexer are connected to one first control line, the first electrodes of all the first thin film transistors in the first multiplexer are connected to different second signal lines respectively, and the first electrodes of the first thin film transistors located at the same relative position in the corresponding first multiplexers of the plurality of first multiplexers are connected to one first signal line; and the non-display region comprises the first control line.

4. The display panel according to claim 2, wherein the first control electrode in the first multiplexer are connected to different first control lines respectively, all the first electrodes in the first multiplexer are connected to one second signal line, and the first control electrodes of the first thin film transistors located at the same relative position in the plurality of first multiplexers are connected to one first control line; and the non-display region comprises the first control line.

5. The display panel according to claim 1, wherein in a case that the first region group comprises a plurality of regions arranged in the second direction, the display region further internally comprises a plurality of third signal lines arranged in the second direction, and the third signal lines are electrically connected to the pixel sub-electrodes in the pixels arranged in the first direction;
the non-display region further comprises:
a plurality of fourth signal lines corresponding to the first direction, and a plurality of second multiplexers, the second multiplexers correspond to second region groups, the second region group consist of a plurality of regions located at the same arrangement position in each first region group of the plurality of first region groups, the plurality of second multiplexers share the plurality of fourth signal lines, and output ends of the second multiplexers are connected to the third signal lines in the second region groups one to one; and
the plurality of second multiplexers, under control of a second gating signal, transmit signals on the plurality of fourth signal lines into the corresponding second region groups in a time-sharing manner, and in conjunction with the first gating signal corresponding to the plurality of first multiplexers, cause all the pixel sub-electrodes corresponding to each row of pixels in the first region groups to be simultaneously loaded with corresponding voltages, or cause all the pixel sub-electrodes corresponding to one scanning line in the display region to be simultaneously loaded with corresponding voltages.

6. The display panel according to claim 5, wherein each of the second multiplexers comprises:
a plurality of second thin film transistors in one-to-one correspondence with the third signal lines in the second region group; and
each of the second thin film transistor comprises a second control electrode, a third electrode and a fourth electrode, and each fourth electrode is connected to one of the third signal lines in the corresponding second region group.

7. The display panel according to claim 6, wherein the second control electrodes of all the second thin film transistors in the second multiplexer are connected to one second control line, the fourth electrodes of all the second thin film transistors in the second multiplexer are connected to different third signal lines respectively, and the third electrodes of the second thin film transistors located at the same relative position in the corresponding second multiplexers of the plurality second multiplexers are connected to one fourth signal line; and the non-display region comprises the second control line.

8. The display panel according to claim 6, wherein the second control electrodes in the second multiplexer are connected to different second control lines respectively, all the third electrodes in the second multiplexer are connected to one fourth signal line, and the fourth electrodes of the second thin film transistors located at the same relative position in the plurality of second multiplexers are connected to the different third signal lines; and the non-display region comprises the second control lines.

9. The display panel according to claim 1, wherein the non-display region further comprises:
a scanning driving circuit and a data driving circuit;
when the first signal lines are data lines, the second signal lines are connected between the data driving circuit and the corresponding first multiplexers;
when the first signal lines are scanning lines, the second signal lines are connected between the scanning driving circuit and the corresponding first multiplexers; and
in a case that the first region groups comprise the plurality of regions, when the first signal lines are one of the data lines or the scanning lines and the second signal lines are the other of the data lines or the scanning lines, the second signal lines are connected between one of the data driving circuit or the scanning driving circuit and the corresponding first multiplexers, and the fourth signal lines are connected between the other of the data driving circuit or the scanning driving circuit and the corresponding second multiplexers.

10. The display panel according to claim 9, wherein the non-display region further comprises a first control circuit and a second control circuit, the first control lines are connected between the first control circuit and the corresponding first multiplexers, and the second control lines are connected between the second control circuit and the corresponding second multiplexers; and
the first control circuit and the second control circuit comprise the scanning driving circuit and the data driving circuit.

11. The display panel according to claim 1, wherein each of the pixels further comprises:
a plurality of third thin film transistors in one-to-one correspondence with the plurality of pixel sub-electrodes;
each of the third thin film transistors comprises a third control electrode, a fifth electrode and a sixth electrode, and each sixth electrode is connected to the corresponding pixel sub-electrode;
in a case that the first region group has one region and the first signal lines are the scanning lines, the third control electrodes of the plurality of third thin film transistors are electrically connected to different first signal lines, and the fifth electrodes of the plurality of third thin film transistors are connected to one data line;
in a case that the first region group has one region and the first signal lines are the data lines, the third control electrodes of the plurality of third thin film transistors are electrically connected to one scanning line, and the fifth electrodes of the plurality of third thin film transistors are connected to different first signal lines; and
in a case that the first region group has a plurality of regions, the third control electrodes of the third thin film transistors are electrically connected to the scanning lines, and the fifth electrodes of the third thin film transistors are connected to the data lines.

12. The display panel according to claim 1, wherein the pixels further comprise a plurality of charged particles, and the plurality of charged particles comprise:
a plurality of first color charged particles, and a plurality of second color charged particles electrically opposite to the first color charged particles.

13. A driving method based on the display panel according to claim 1, comprising:
loading voltages corresponding to corresponding rows of pixel sub-electrodes simultaneously row by row in a display region;
or, controlling all pixel sub-electrodes corresponding to each row of pixels in each first region group of the plurality of first region groups contained in the display region to be loaded with corresponding voltages simultaneously.

14. The driving method according to claim 13, wherein the controlling all pixel sub-electrodes corresponding to each row of pixels in each first region group of the plurality of first region groups contained in the display region to be loaded with corresponding voltages simultaneously comprises:
loading, one by one, all the pixel sub-electrodes contained in each row of pixels in the first region groups corresponding to first multiplexers with corresponding voltages simultaneously until the voltages corresponding to all the pixel sub-electrodes corresponding to the last row of pixels in the corresponding first region groups are loaded; and
loading the voltages of the pixel sub-electrodes corresponding to the next first region group after loading the voltages corresponding to all the pixel sub-electrodes in one first region group every time until the voltages corresponding to all the pixel sub-electrodes in the last first region group are loaded.

15. The driving method according to claim 13, wherein the controlling all pixel sub-electrodes corresponding to each row of pixels in each first region group of the plurality of first region groups contained in the display region to be loaded with corresponding voltages simultaneously comprises:
controlling, row by row, all the pixel sub-electrodes in the corresponding row of pixels in all the first region groups in the same one pixel row to be loaded with the corresponding voltages simultaneously until the voltages of the pixel sub-electrodes of the last row of pixels are loaded.

16. A display apparatus, comprising the display panel according to claim 1.

17. The display panel according to claim 2, wherein in a case that the first region group comprises a plurality of regions arranged in the second direction, the display region further internally comprises a plurality of third signal lines arranged in the second direction, and the third signal lines are electrically connected to the pixel sub-electrodes in the pixels arranged in the first direction;
the non-display region further comprises:
a plurality of fourth signal lines corresponding to the first direction, and a plurality of second multiplexers, the second multiplexers correspond to second region groups, the second region group consist of a plurality of regions located at the same arrangement position in each first region group of the plurality of first region groups, the plurality of second multiplexers share the plurality of fourth signal lines, and output ends of the second multiplexers are connected to the third signal lines in the second region groups one to one; and
the plurality of second multiplexers, under control of a second gating signal, transmit signals on the plurality of fourth signal lines into the corresponding second region groups in a time-sharing manner, and in conjunction with the first gating signal corresponding to the plurality of first multiplexers, cause all the pixel sub-electrodes corresponding to each row of pixels in the first region groups to be simultaneously loaded with corresponding voltages, or cause all the pixel sub-electrodes corresponding to one scanning line in the display region to be simultaneously loaded with corresponding voltages.

18. The display panel according to claim 3, wherein in a case that the first region group comprises a plurality of regions arranged in the second direction, the display region further internally comprises a plurality of third signal lines arranged in the second direction, and the third signal lines are electrically connected to the pixel sub-electrodes in the pixels arranged in the first direction;
the non-display region further comprises:
a plurality of fourth signal lines corresponding to the first direction, and a plurality of second multiplexers, the second multiplexers correspond to second region groups, the second region group consist of a plurality of regions located at the same arrangement position in each first region group of the plurality of first region groups, the plurality of second multiplexers share the plurality of fourth signal lines, and output ends of the second multiplexers are connected to the third signal lines in the second region groups one to one; and
the plurality of second multiplexers, under control of a second gating signal, transmit signals on the plurality of fourth signal lines into the corresponding second region groups in a time-sharing manner, and in conjunction with the first gating signal corresponding to the plurality of first multiplexers, cause all the pixel sub-electrodes corresponding to each row of pixels in the first region groups to be simultaneously loaded with corresponding voltages, or cause all the pixel sub-electrodes corresponding to one scanning line in the display region to be simultaneously loaded with corresponding voltages.

19. The display panel according to claim 2, wherein the non-display region further comprises:
a scanning driving circuit and a data driving circuit;
when the first signal lines are data lines, the second signal lines are connected between the data driving circuit and the corresponding first multiplexers;
when the first signal lines are scanning lines, the second signal lines are connected between the scanning driving circuit and the corresponding first multiplexers; and
in a case that the first region groups comprise the plurality of regions, when the first signal lines are one of the data lines or the scanning lines and the second signal lines are the other of the data lines or the scanning lines, the second signal lines are connected between one of the data driving circuit or the scanning driving circuit and the corresponding first multiplexers, and the fourth signal lines are connected between the other of the data driving circuit or the scanning driving circuit and the corresponding second multiplexers.

20. The display panel according to claim 3, wherein the non-display region further comprises:
a scanning driving circuit and a data driving circuit;
when the first signal lines are data lines, the second signal lines are connected between the data driving circuit and the corresponding first multiplexers;
when the first signal lines are scanning lines, the second signal lines are connected between the scanning driving circuit and the corresponding first multiplexers; and
in a case that the first region groups comprise the plurality of regions, when the first signal lines are one of the data lines or the scanning lines and the second signal lines are the other of the data lines or the scanning lines, the second signal lines are connected between one of the data driving circuit or the scanning driving circuit and the corresponding first multiplexers, and the fourth signal lines are connected between the other of the data driving circuit or the scanning driving circuit and the corresponding second multiplexers.
